(19) United States
(12) Patent Application Publication
(10) Pub. No.: US 2018/0299126 A1
(43) Pub. Date: Oct. 18, 2018

(54) COMBUSTOR LINER PANEL END RAIL

(71) Applicant: United Technologies Corporation, Farmington, CT (US)

(72) Inventor: JinQuan Xu, East Greenwich, RI (US)

(21) Appl. No.: 15/490,089

(22) Filed: Apr. 18, 2017

(51) Int. Cl. F23R 3/00; F23R 3/06

(52) U.S. Cl. CPC F23R 3/002; F23R 3/06; F05D 2260/202; F23R 2900/03044; F23R 2900/03042; F05D 2260/201; F05D 2240/35

(57) ABSTRACT

A combustor section of a turbine engine includes a first liner panel including a first portion and a second portion defining a continuous uninterrupted surface. The second portion extends away from the first portion at an angle in cross-section greater than 180 degrees beginning at an inflection point. A combustor assembly for a turbine engine and a method of assembling a combustor for a turbine engine are also disclosed.

### BACKGROUND

A gas turbine engine typically includes a fan section, a compressor section, a combustor section and a turbine section. Air entering the compressor section is compressed and delivered into the combustion section where it is mixed with fuel and ignited to generate a high-energy exhaust gas flow. The high-energy exhaust gas flow expands through the turbine section to drive the compressor and the fan section. The compressor section typically includes low and high pressure compressors, and the turbine section includes low and high pressure turbines.

The combustor section includes a chamber where the fuel/air mixture is ignited to generate the high energy exhaust gas flow. The temperatures within the combustor chambers are typically beyond practical material capabilities. Therefor liner panels are provided within the chamber that are cooled by a cooling airflow. The cooing airflow impinges on the liner panel and also is injected along the surface of the liner panel to provide an insulating film of cooling air. Disruptions or gaps in cooling airflow may result in temperatures greater than desired in certain portions of the liner panel. Higher liner panel temperatures can result in premature degradation and loss of combustor efficiency.

### SUMMARY

In a featured embodiment, a combustor section of a turbine engine includes a first liner panel including a first portion and a second portion defining a continuous uninterrupted surface. The second portion extends away from the first portion at an angle in cross-section greater than 180 degrees beginning at an inflection point.

In another embodiment according to the previous embodiment, includes a second liner panel disposed abutting the first liner panel, and an interface between the first liner panel and the second liner panel transverse to an engine longitudinal axis and spaced axially from the inflection point.

In another embodiment according to any of the previous embodiments, includes a radial distance (r) at the inflection point between an inner wall and an outer wall and the interface is spaced axially from the inflection point a distance greater than one quarter the radial distance (r).

In another embodiment according to any of the previous embodiments, the inner wall and the outer wall define an annular combustor disposed about the engine longitudinal axis.

In another embodiment according to any of the previous embodiments, the second liner panel is disposed aft of the first liner panel.

In another embodiment according to any of the previous embodiments, the second liner panel is disposed forward of the first liner panel.

In another embodiment according to any of the previous embodiments, the first liner panel includes a first end rail and the second liner panel includes a second end rail and the first end rail is adjacent the second end rail at the interface. The first end rail and the second end rail are disposed transverse to the engine longitudinal axis.

In another embodiment according to any of the previous embodiments, the first end rail is spaced an axial distance the second end rail.

In another featured embodiment, a combustor assembly for a turbine engine includes an inner wall disposed about an engine axis. An outer wall is spaced radially apart from the inner wall. The inner wall and outer wall converge toward each other beginning at a forward portion to an inflection point and extend at an angle greater than 180 degrees from the inflection point to an aft end. A first liner panel includes a first portion forward of the inflection point and a second portion aft of the inflection point. The first liner panel includes first end rails transverse to the engine axis. A second liner panel includes second end rails transverse to the engine axis. One of the second end rails adjacent one of the first end rails at an interface spaced axially from the inflection point.

In another embodiment according to any of the previous embodiments, includes a radial distance R between the inner wall and the outer wall at the inflection point and the interface is spaced from the inflection point an axial distance greater than one quarter the radial distance R.

In another embodiment according to any of the previous embodiments, the interface is disposed aft of the inflection point.

In another embodiment according to any of the previous embodiments, the interface is disposed forward of the inflection point.

In another embodiment according to any of the previous embodiments, the first liner defines a single continuous surface through the inflection point.

In another embodiment according to any of the previous embodiments, the single continuous surface includes a plurality of cooling air holes injecting cooling air into through first liner panel.

In another embodiment according to any of the previous embodiments, the first liner panel includes a plurality of first liner panels arranged circumferentially about the engine axis and the second liner panel includes a plurality of second liner panels arranged circumferentially about the engine axis.

In another featured embodiment, a method of assembling a combustor for a turbine engine includes assembling an inner wall disposed about an engine axis. An outer wall spaced radially apart from the inner wall is assembled. The inner wall and outer wall converge toward each other beginning at a forward portion to an inflection point and extend at an angle greater than 180 degrees from the inflection point to an aft end. A first liner panel is assembled to at least one of the inner wall and the outer wall. The first liner panel includes a first portion forward of the inflection point and a second portion aft of the inflection point. The first liner includes first end rails transverse to the engine axis. A second liner panel is assembled to at least one of the inner wall and the outer wall. The second liner panel includes second end rails transverse to the engine axis. One of the second end rails is assembled adjacent one of the first end rails at an interface spaced axially from the inflection point.

In another embodiment according to any of the previous embodiments, includes defining a radial distance R between the inner wall and the outer wall at the inflection point and spacing the interface from the inflection point an axial distance greater than one quarter the radial distance R.

In another embodiment according to any of the previous embodiments, the interface is disposed one of aft of the inflection point and forward of the inflection point.

In another embodiment according to any of the previous embodiments, includes assembling the first liner panel to define a single continuous surface through the inflection point.

Although the different examples have the specific components shown in the illustrations, embodiments of this disclosure are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWINGS

FIG. 1 is a schematic view of an example gas turbine engine.

FIG. 2 is a perspective view of a portion of an example combustor assembly.

FIG. 3 is a schematic cross-sectional view of a portion of the combustor assembly.

FIG. 4 is an enlarged view of a wall portion of the combustor assembly.

FIG. 5 is another schematic cross-sectional view of a portion of another combustor assembly embodiment.

### DETAILED DESCRIPTION

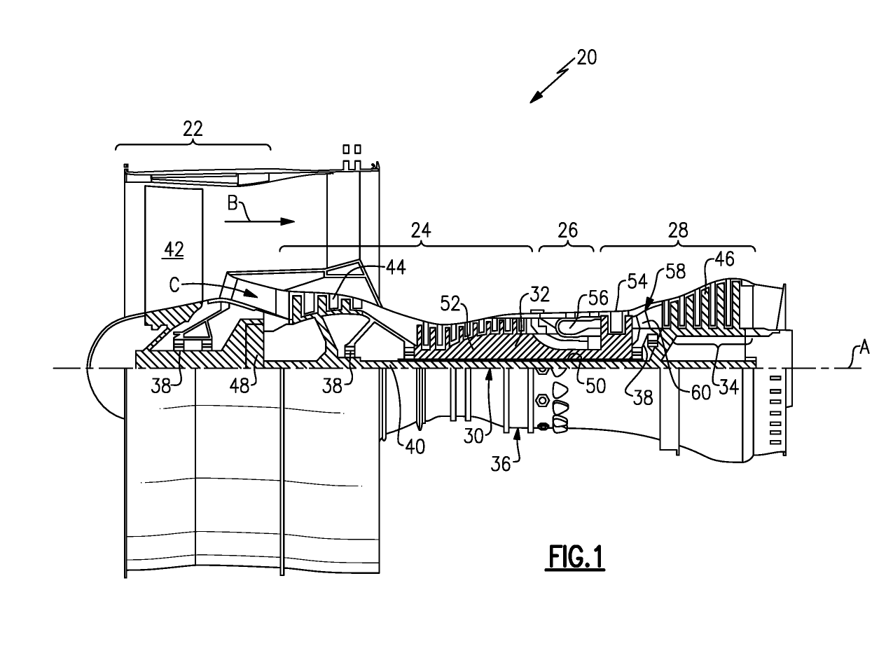

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flow path B in a bypass duct defined within a nacelle 15, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a first (or low pressure) compressor 44 and a first (or low pressure) turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a second (or high pressure) compressor 52 and a second (or high pressure) turbine 54. A combustor 56 is arranged in the exemplary gas turbine 20 between the high pressure compressor 52 and the high pressure turbine 54. A mid-turbine frame 58 of the engine static structure 36 is arranged generally between the high pressure turbine 54 and the low pressure turbine 46. The mid-turbine frame 58 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The mid-turbine frame 58 includes airfoils 60 which are in the core airflow path C. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five 5:1. The low pressure turbine 46 pressure ratio is pressure measured prior to inlet of the low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present invention is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet (10,668 meters). The flight condition of 0.8 Mach and 35,000 ft (10,668 meters), with the engine at its best fuel consumption—also known as “bucket cruise Thrust Specific Fuel Consumption (′TSFC)”—is the industry standard parameter of 1 bm of fuel being burned divided by 1 bf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram °R)/(518.7 °R)]^{0.5}. The “Low corrected fan tip speed” as disclosed herein according to one non-limiting embodiment is less than about 1150 ft/second (350.5 meters/second).

The example gas turbine engine includes the fan 42 that comprises in one non-limiting embodiment less than about twenty-six (26) fan blades. In another non-limiting embodiment, the fan section 22 includes less than about twenty (20) fan blades. Moreover, in one disclosed embodiment the low pressure turbine 46 includes no more than about six (6) turbine rotors schematically indicated at 34. In another non-limiting example embodiment the low pressure turbine 46 includes about three (3) turbine rotors. A ratio between the number of fan blades 42 and the number of low pressure turbine rotors is between about 3.3 and about 8.6. The example low pressure turbine 46 provides the driving power to rotate the fan section 22 and therefore the relationship between the number of turbine rotors 34 in the low pressure turbine 46 and the number of blades 42 in the fan section 22 disclose an example gas turbine engine 20 with increased power transfer efficiency.

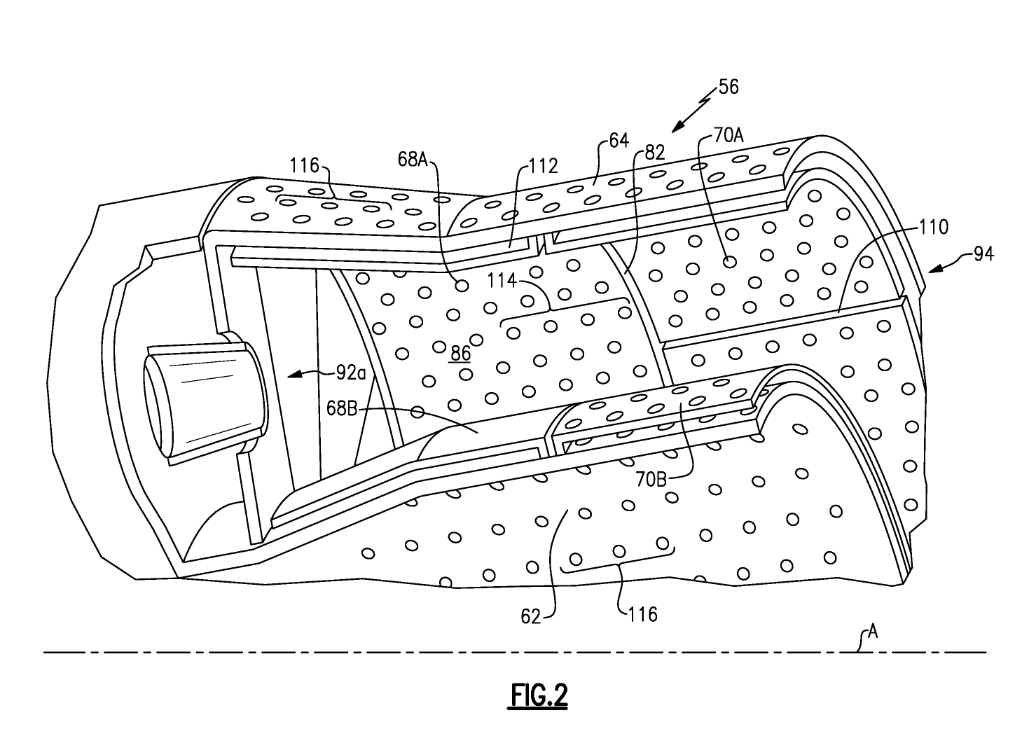

Referring to FIG. 2, the example combustor 56 includes an outer wall 64 and an inner wall 62 to define a generally annular chamber 86 disposed about the engine axis A. The inner wall 62 and the outer wall 64 are radially spaced apart to define the annular chamber 86. Each of the inner wall 62 and outer wall 64 support liner panels 68a-b and 70a-b that define an inner surface of the combustion chamber 86. The liner panels 68a-b, 70a-b define the inner surface and are cooled with airflow through a plurality of cooling air holes 114. The combustion chamber 86 reaches temperatures that are not suitable for most materials. Accordingly, cooling airflow is provided through the cooling air holes 114 to maintain the liner panels 68a-b, 70a-b within an acceptable temperature ranges.

The inner and outer wall 62, 64 also include a plurality of cooling impingement holes 116 that allow air to enter a plenum 112 and impinge on a cold side of the liner panels 68a-b, 70a-b. Air that goes through the inner and outer walls 62, 64 impacts on the surface of liner panels 68a-b, 70a-b that define the interior surfaces of the combustion chamber 86. Air within the plenums 112 is directed through the cooling film holes 114 that inject air into the combustor chamber 86 to create an insulating cooling airflow flow that maintains the surfaces of the panels 68a-b, 70a-b at temperatures within material limits.

The panels 68a, 68b, 70a and 70b are representative of a plurality of panels that extend from a forward portion 92 of the combustor 56 to an aft portion 94 of the combustor 56. The panels 68a, 68b, 70a and 70b are disposed circumferentially about the engine axis A and extend axially. The panels 68a, 68b, 70a and 70b are spaced apart along radial interfaces 82 and axial interfaces 110.

Referring to FIG. 3 with continued reference to FIG. 2, the inner wall 62 is disposed within an inner shell 66 and the outer wall 64 is disposed within an outer wall 72. The inner shell 66 and the outer shell 72 are spaced radially apart and define an annular cavity within which the combustor assembly 56 is disposed.

The example combustor assembly 56 includes the first panel 68a that includes a first portion 74a and a second portion 76a. The inner wall 62 supports a corresponding first panel 68b that includes a first portion 74b and a second portion 76b. The combustion chamber 86 includes an initial converging region 95 that extends from the forward portion 92 to an inflection point 84. At the inflection point 84, the walls 62, 64 of the combustor chamber 86 bend away from the converging direction and extend in a more linear direction in an aft region 97 such that the combustor walls 62, 64 either converge toward each other at a decreased angle in a radial direction or no longer converge toward each other in the radial direction.

In the disclosed example, one or both the walls 62, 64 after the inflection point 84 are disposed at an angle greater than 180° relative to a wall prior to the inflection angle 84.

The first panel 68a includes the first portion 74a that is disposed prior to the inflection point 84 and the second portion 76a that is disposed after the inflection point 84. An angle 90 between the first portion 74a and the second portion 76a is greater than 180 degrees. A second panel 70a is abutted against the first panel 68a at an interface 82a. At the interface 82a, end rails of the first panel 68a and the second panel 70a abut one another. The first panel 68a extends from the forward portion 92 past the inflection portion 84 to the interface 82a with the second liner panel 70a.

The first liner panel 68a defines a single, continuous uninterrupted surface from the forward portion 92 past the inflection portion 84 to the interface 82a. In this disclosure the continuous uninterrupted surface does not include an interface between adjacent liner panels. Additionally, the first liner panel 68a includes the continuous uninterrupted surface in an axial direction. The first liner panel 68a may include a plurality of first liner panels 68a positioned adjacent to each other circumferentially and may include axially extending interfaces between the adjacent liner panels 68a. The integrated construction of the first liner panel 68a moves the interface 82a away from the inflection point 84 to provide improved thermal capabilities. The interface 82a is provided at a location removed from the inflection point 84a to limit effects of aerodynamic instability on thermal properties of the first liner panel 68a. Location of the interface 82a away from the inflection point 84 moves the interface away from a turbulent airflow region that may detrimentally affect the end rails of each of the panels.

The inner wall 62 also includes the first liner panel 68b that includes the first portion 74b and the second portion 76b that defines one continuous uninterrupted surface through the inflection point 84. The second portion 76b is angled away from the first portion 74b at an angle 90b that is greater than 180 degrees. The first liner panel 68b abuts a second liner panel 70b at the interface 82b. The inter face 82b is spaced aft of the inflection point 84.

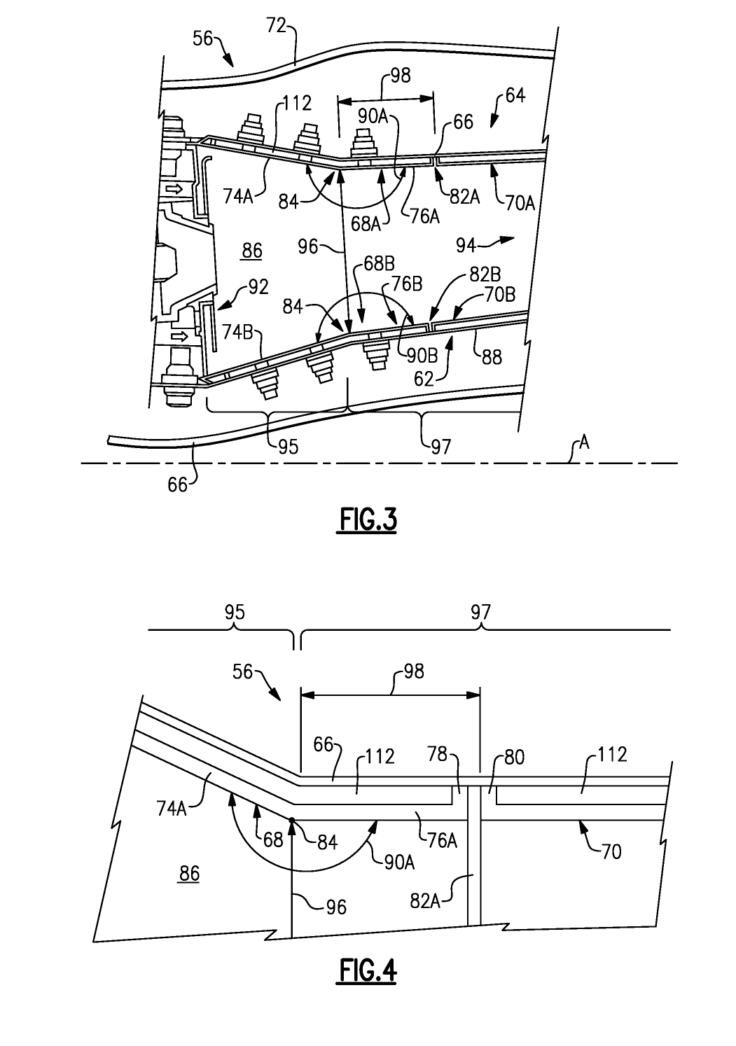

Referring to FIG. 4 with continued reference to FIG. 3, an enlarged view of the interface 82a between the first panel 68a and the second panel 70a is shown and is spaced apart from the inflection point 84. In this example, the interface 82a is spaced apart from the inflection point 84, a distance (L) 98 that is at least one quarter the radius (r) 96 between the inner and outer walls 62, 64 at the inflection point 84. In another example embodiment, the interface 82a is spaced apart from the inflection point 84 a distance (L) that is at least one half the radius (r) 96. The inflection point 84 is that location where the first portion 74a of the first liner panel 68a changes direction such that the second portion 76a extends outward in a more linear direction. Moreover, it is within the contemplation of this disclosure that the first liner panel 68a may extend linearly, converge at a lesser angle, or diverge radially aft of the inflection point 84. In the disclosed example embodiment, the angle 90a between the first portion 74a and the second portion 76a is greater than 180 degrees.

The second portions 76a flattens out to provide a non-converging or less converging portion of the combustor 86. The interface 82a between the first panel 68a and the second panel 70a is within the aft region 97 and spaced apart from the inflection point 84. In this location, end rails 78 of the first panel 68a and end rail 80 of the second panel 70a abut one another to define the interface 82. Because the interface 82a is spaced apart from the inflection point 84, airflow is more uniform along the interface 82a and therefore does not create damaging turbulent airflow within the region.

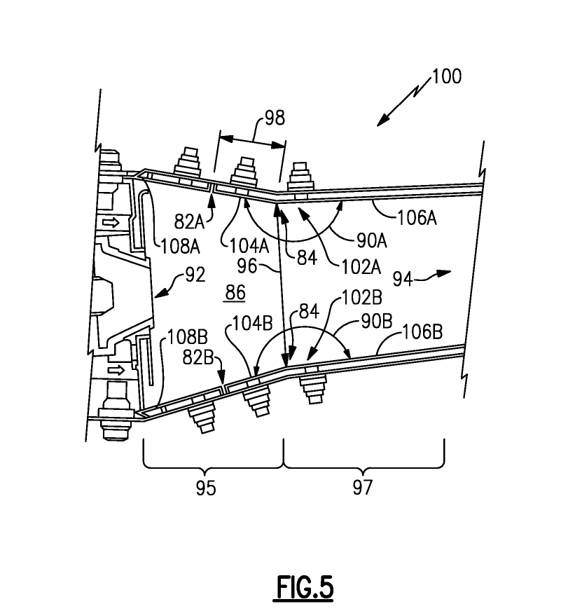

Referring to FIG. 5, another example combustor assembly 100 includes the interfaces 82a-b that is spaced apart from the inflection point 84 within the converging region 95 of the combustor chamber 86. The interfaces 82a-b are spaced toward the forward portion 92 of the combustor 100. In this example, a first panel 108a extends a limited distance within the converging region 95 of the combustor chamber 86. A second panel 102a includes a first portion 104a and a second portion 106a. The first portion 104a and the second portion 106a form one continuous uninterrupted surface that extends over the inflection point 84. The interface 82a is therefore disposed forward of the inflection point 84 at a distance 98 from the inflection point 84. The distance 98 may be one quarter the radius 96 between the inner and outer walls 62, 64 at the inflection point 84, in one example.

Accordingly, the example combustor assembly moves the interface between abutting panels away from the inflection point to limit detrimental effects that may occur due to complicated and turbulent airflow and stabilities that are created around the interfaces between liner panels.

Although an example embodiment has been disclosed, a worker of ordinary skill in this art would recognize that certain modifications would come within the scope of this disclosure. For that reason, the following claims should be studied to determine the scope and content of this disclosure.

What is claimed is:

1. A combustor section of a turbine engine comprising:
a first liner panel including a first portion and a second portion defining a continuous uninterrupted surface, wherein the second portion extends away from the first portion at an angle in cross-section greater than 180 degrees beginning at an inflection point.

2. The combustor section as recited in claim 1, including a second liner panel disposed abutting the first liner panel, and an interface between the first liner panel and the second liner panel transverse to an engine longitudinal axis and spaced axially from the inflection point.

3. The combustor section as recited in claim 2, including a radial distance (r) at the inflection point between an inner wall and an outer wall and the interface is spaced axially from the inflection point a distance greater than one quarter the radial distance (r).

4. The combustor section as recited in claim 3, wherein the inner wall and the outer wall define an annular combustor disposed about the engine longitudinal axis.

5. The combustor section as recited in claim 2, wherein the second liner panel is disposed aft of the first liner panel.

6. The combustor section as recited in claim 2, wherein the second liner panel is disposed forward of the first liner panel.

7. The combustor section as recited in claim 2, wherein the first liner panel includes a first end rail and the second liner panel includes a second end rail and the first end rail is adjacent the second end rail at the interface, wherein the first end rail and the second end rail are disposed transverse to the engine longitudinal axis.

8. The combustor section as recited in claim 7, wherein the first end rail is spaced an axial distance the second end rail.

9. A combustor assembly for a turbine engine comprising:
an inner wall disposed about an engine axis;
an outer wall spaced radially apart from the inner wall, wherein the inner wall and outer wall converge toward each other beginning at a forward portion to an inflection point and extend at an angle greater than 180 degrees from the inflection point to an aft end;
a first liner panel including a first portion forward of the inflection point and a second portion aft of the inflection point, the first liner panel including first end rails transverse to the engine axis; and
a second liner panel including second end rails transverse to the engine axis, one of the second end rails adjacent one of the first end rails at an interface spaced axially from the inflection point.

10. The combustor assembly as recited in claim 9, including a radial distance R between the inner wall and the outer wall at the inflection point and the interface is spaced from the inflection point an axial distance greater than one quarter the radial distance R.

11. The combustor assembly as recited in claim 9, wherein the interface is disposed aft of the inflection point.

12. The combustor assembly as recited in claim 9, wherein the interface is disposed forward of the inflection point.

13. The combustor assembly as recited in claim 9, wherein the first liner defines a single continuous surface through the inflection point.

14. The combustor assembly as recited in claim 13, wherein the single continuous surface comprises a plurality of cooling air holes injecting cooling air into through first liner panel.

15. The combustor assembly as recited in claim 9, wherein the first liner panel comprises a plurality of first liner panels arranged circumferentially about the engine axis and the second liner panel comprises a plurality of second liner panels arranged circumferentially about the engine axis.

16. A method of assembling a combustor for a turbine engine comprising:
assembling an inner wall disposed about an engine axis;
assembling an outer wall spaced radially apart from the inner wall, wherein the inner wall and outer wall converge toward each other beginning at a forward portion to an inflection point and extend at an angle greater than 180 degrees from the inflection point to an aft end;
assembling a first liner panel to at least one of the inner wall and the outer wall, the first liner panel including a first portion forward of the inflection point and a second portion aft of the inflection point, the first liner including first end rails transverse to the engine axis;
assembling a second liner panel to at least one of the inner wall and the outer wall, the second liner panel including second end rails transverse to the engine axis; and
assembling one of the second end rails adjacent one of the first end rails at an interface spaced axially from the inflection point.

17. The method as recited in claim 16, including defining a radial distance R between the inner wall and the outer wall at the inflection point and spacing the interface from the inflection point an axial distance greater than one quarter the radial distance R.

18. The method as recited in claim 17, wherein the interface is disposed one of aft of the inflection point and forward of the inflection point.

19. The method as recited in claim 16, including assembling the first liner panel to define a single continuous surface through the inflection point.
